(19) United States
(12) Patent Application Publication
(10) Pub. No.: US 2010/0098913 A1
(43) Pub. Date: Apr. 22, 2010

(54) DEVICE AND METHOD FOR PROTECTION AND ACTIVATION OF SENSORS

(75) Inventors: Massimiliano Cavallini, Vergato (IT); Fabio Biscarini, Bologna (IT); Francesco Cino Matacotta, Bologna (IT); Gianluca Massaccesi, Casalecchio Di Reno (IT)

Correspondence Address: SCULLY SCOTT MURPHY & PRESSER, PC, 400 GARDEN CITY PLAZA, SUITE 300, GARDEN CITY, NY, 11530, US

(73) Assignee: SCRIBA NANOTECNOLOGIE S.R.L., Bologna (IT)

(21) Appl. No.: 12/529,800

(22) PCT Filed: Mar. 6, 2008
(86) PCT No.: PCT/EP08/52740

§ 371 Date: Sep. 3, 2009

(30) Foreign Application Priority Data
Mar. 9, 2007 (IT) BO2007A000159

(51) Int. Cl. B32B 3/30

(52) U.S. Cl. 428/167

(57) ABSTRACT

A device and a corresponding method which allows to protect, preserve and activate (making it sensitive to external agents) a sensitive element, which changes its morphology and/or produces phase segregations following exposure to external agents.

### TECHNICAL FIELD

The present invention relates to a device and to a corresponding method which allows to protect, preserve and activate (making it sensitive to external agents) a sensitive element, which changes its morphology and/or produces phase segregations following exposure to external agents.

### BACKGROUND ART

The quality and safety of a large number of perishable products are influenced by temperature and/or exposure to electromagnetic radiation and/or exposure to chemical agents and/or exposure to physical agents et cetera.

A number of devices with sensor capability, i.e., provided with a sensitive element, with varying degrees of complexity, have been developed for monitoring exposure to these parameters.

Among existing sensor devices, structured sensitive labels are particularly important. These labels reveal their exposure to external agents as a consequence of chemical and/or physical variations, which comprise: color changes, shape changes, changes in thermal and/or electrical conductivity, thermally induced chemical reactions, phase segregations and others.

Particularly but not exclusively, such products or sensors are applied in the preservation of refrigerated and frozen foodstuffs, beverages which require preservation at controlled temperatures, such as wine, certain cosmetic, medical, pharmaceutical products, and others.

For example, some among the main factors that contribute to loss of hygienic and sanitary, nutritional or visual quality of perishable products are time and temperature: more specifically, the passing of a critical temperature threshold which interrupts the “cold chain” from the manufacturer to the consumer of the product, and/or its exposure for a significantly long time to a temperature which is higher than the temperature prescribed for safe preservation during a guaranteed preservation period. It should be added that the expiration date of a product is an indication for preservation according to the correct specifications. The indicated date is actually estimated conservatively, in the case of a properly preserved product, whereas it becomes entirely meaningless in case of a change in the preservation conditions.

Other commonly used products, such as fabrics, also can deteriorate if they are exposed to chemical and/or physical external agents, for example during their preservation.

Therefore, control and monitoring of exposure to chemical and/or physical agents are very important during processing, maintenance, storage and distribution of a product and have become an essential requirement of society and of the production and distribution chain.

Among the several types of sensors that have been proposed, many base their operation on chemical and/or physical changes of the sensor itself, linked to morphological changes.

One of the main problems that limit greatly the development and application of these sensors is related to their own preservation: the sensitive elements of the sensors in fact must not be exposed to the agents to which they are sensitive before they are applied to the product itself. This aspect is particularly critical in the case of sensors which are sensitive to low temperatures (for example preservation of elements which must remain frozen) and of sensors based on morphological changes. The need to preserve the sensor before it is actually used therefore entails considerable practical complications, since even before its actual use it must be stored appropriately, and this can entail the use of extreme or expensive conditions such as freezing.

### DISCLOSURE OF THE INVENTION

The aim of the present invention is to provide a device and a method which allow to activate the sensitive element of a sensor only at the selected time, allowing to preserve the sensitive element (before activation) in ambient conditions, including the conditions to which the sensitive element is sensitive after activation.

In particular, the present invention relates to a film of any thickness and material which contains at least one structured element and is arranged on the product or sensor which, following its total or partial removal, determines the exposure and activation of the active part of the product or sensor to the chemical and/or physical agents to which it is sensitive.

An object of the present invention is to provide a device and a method for activation and/or protection of sensitive elements which sense temperature.

Another object of the invention is to provide a device and a method for activation and/or protection of elements which are sensitive to chemical and/or physical agents.

Another object of the invention is to provide a device and a method for activation and/or protection of sensitive elements easy and safe to apply to any type of product, even of the food or medical-pharmaceutical type.

Still another object of the invention is to provide a device and a method for the activation and/or protection of products or sensors which can be obtained with known materials which are internationally acceptable as compatible with particular uses, such as those in the food or medical-pharmaceutical field and are easily commercially available.

The protective film is spatially structured and contains the spatial patterns with negative morphology (hereinafter also referenced as mirror-symmetrical elements) with respect to the patterns provided on the sensitive element. The presence of the spatially structured protective layer maintains the morphological shape of the elements of the sensitive element even when the sensitive element is subjected to chemical and/or physical stimuli which would modify its characteristics. The material of the spatially structured protective layer must not be sensitive to the same chemical and physical parameters that modify the sensitive element. Activation is determined by the removal of the spatially structured protective layer.

### WAYS OF CARRYING OUT THE INVENTION

Further characteristics and advantages of the invention will become better apparent from the description of preferred but not exclusive embodiments of the device and of the method according to the invention, illustrated by way of non-limiting example in the accompanying figures, wherein:

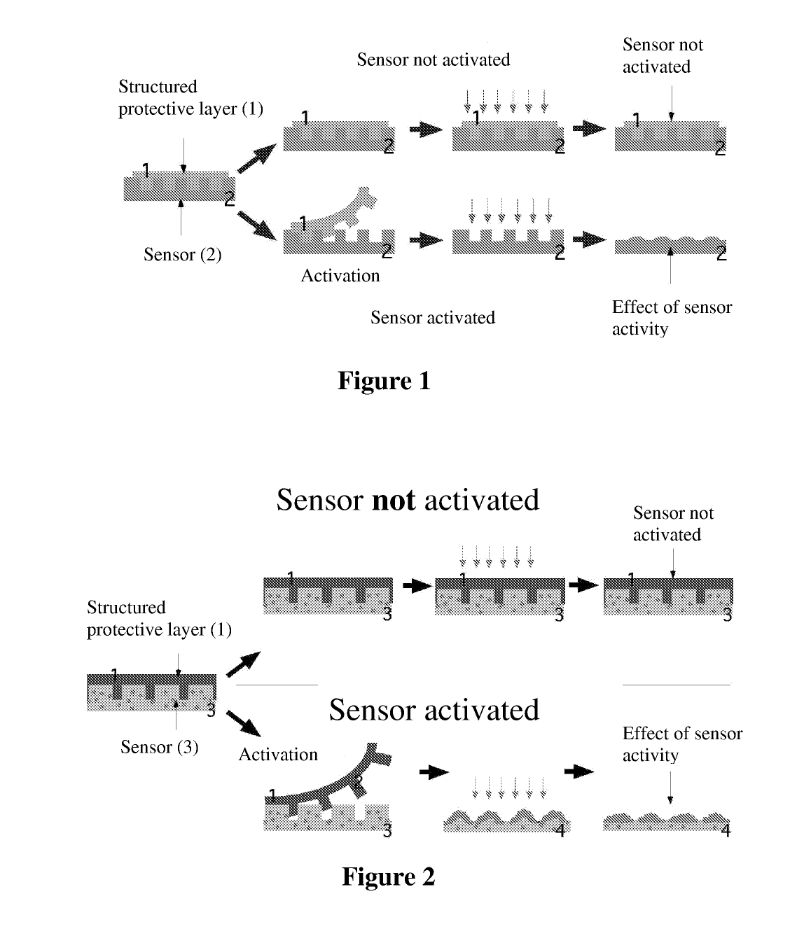

FIG. 1 is a schematic view of the possible behavior of the device, in a first embodiment according to the invention, during absorption for example of heat, with protection of the morphology of the sensitive element against melting and/or smoothing of the material of which the sensor is made (see M. Cavallini et al., WO 2007/039094). The device according to FIG. 1 consists of a protective film 1 which contains the mirror-symmetrical structures of the sensitive element 2 and is arranged above the sensitive element 2. If the structured film 1 is not removed (device not activated), it prevents the sensitive element 2 from changing its morphology even when it is exposed to the conditions to which the sensitive element 2 is sensitive after activation.

If the film 1 is instead removed, the sensitive element 2 is activated and its morphology changes as a consequence of the thermal stimulus in the conditions to which the sensitive element 2 is sensitive.

FIG. 2 is a schematic view of the possible behavior of the device according to the invention, in a second embodiment, known as phase segregation (see M. Cavallini et al., WO 2005/078521), in which the absorption of heat and/or exposure to chemical agents induces, if activated, a phase segregation of the material of which the product or sensor 3 is made, forming aggregates of substances which are initially dispersed in a matrix 4.

If the structured film 1 is not removed (device not activated), it prevents the sensitive element 2 from modifying its structure and prevents the consequent phase segregation even when it is exposed to the conditions to which the sensitive element 2 is sensitive after activation.

If instead the film 1 is removed, the sensitive element 2 is activated, and in this case its morphology and consequent phase segregation change as a consequence of the external stimulus in the conditions to which the sensitive element 2 is sensitive.

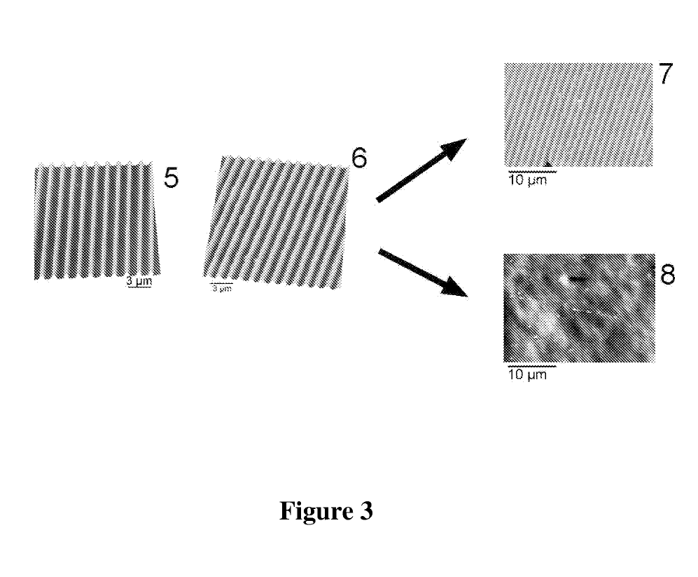

FIG. 3 illustrates a real example of protection and activation of a sensitive element of a temperature sensor according to the first embodiment of FIG. 1. The FIG. 3 illustrates an atomic force microscope image of the device according to the invention where, in particular, a sensor is considered made of polypropylene which is structured so as to change its morphology (smoothing) when it is exposed to a temperature of 75° C. for one minute, wherein the reference numeral 5 designates the morphology of the protective film (device), the reference numeral 6 designates the initial morphology of the sensitive element, the reference numeral 7 designates the morphology of the sensitive element protected by the device after exposure for two minutes to 80° C.; in this last case, the morphology remains unchanged with respect to the initial morphology, designated by the reference numeral 6, even after exposure to the temperature cited above to which the sensitive element is sensitive. The reference numeral 8 in FIG. 3 shows the morphology of said sensitive element after activation, i.e., after removal of the device and after exposure for two minutes to 80° C.; as can be seen, in this case the structures that are present on the sensor disappear completely.

With reference to the accompanying figures and associated explanations, the device for activation of the sensitive element according to the invention comprises at least one spatially structured element, which is constituted by material which is not lo sensitive to the elements to which the sensitive element is sensitive.

The spatially structured element is formed so that it is adapted to be applied to the sensitive element to be protected. The material of which the device is constituted can be selected conveniently among any type of material.

The device therefore bases its operation on blocking the change of morphology and the consequent chemical and/or physical surface alteration of the sensor that is tied to it. The protective structured film can be made of a substantial material (thickness preferably but not exclusively greater than 1 mm) or in the form of a film (thickness preferably but not exclusively from one mm to one μm (1 mm-1 μm) or in the form of a thin film (thickness preferably but not exclusively lower than one μm (1 μm).

In a preferred but not exclusive embodiment, the device consists of a structured thin label, which comprises a base layer with a structured interface or surface which is applied to the sensitive element.

The device can be structured by means of any process for molding or self-structuring or other known suitable method.

The structured film itself can be used as a mold for any structuring of the sensitive element.

Since the structured elements of the sensitive element change appearance and/or size when the label is subjected to a high temperature and/or an external agent for a sufficiently long time, the presence of the device prevents morphology changes thereof.

The device contains elements which are spatially structured on different dimensional scales:
macroscopic scale: the device contains structured elements 1 which have lateral spatial dimensions or widths ranging from five mm to two hundred μm (5 mm-200 μm); the morphological changes of these structures in the sensor and the structures themselves are directly visible even to the naked eye;
micrometer scale: the device contains structures which have lateral spatial dimensions or widths ranging from 200 μm to 1 μm; the morphological changes of these structures in the sensor and the structures themselves are observable directly only with the aid of a specific optical reader or of a microscope;
submicrometer and nanometer scale: the device contains structures 1 having lateral spatial dimensions or widths ranging from 1 μm to 10 nm; the morphological changes in the sensor of these structures and the structures themselves are directly observable with the aid of a specific reader or electron microscope or scanning probe microscope.

For the sake of simplicity in description, reference shall be made hereinafter, without thereby losing generality, only to devices constituted by “films”, although the concept remains valid also for materials of any thickness.

The film is constituted by the structured protective material, which comprises one or more substances, either pure or mixed or stratified. Such substances can belong to the classes of: inorganic, organic, polymeric, biological, hybrid or other nature suitable for the purpose.

The film has at least one surface or interface for protecting the product or sensor with a structured configuration and can be shaped with any molding method or other suitable method, its morphological structure being optionally also spontaneous as a consequence of a technological process for the manufacture or deposition of the film.

From the above description of some preferred but not exclusive embodiments of the device it can be deduced that the invention provides a method for protecting the sensitive element of a sensor which comprises steps for selecting a material constituted by one or more substances capable of not changing state in the preservation conditions of the sensitive element and forming at least one spatially structured element with a morphology which is mirror-symmetrical with respect to the morphology of the sensor.

In practice it has been found that the device and the method for protecting the sensitive element are capable of preventing the activation of the sensitive element until said device is removed. The device therefore allows to preserve the sensitive element of a sensor, and optionally the sensor itself, at very convenient costs. The device according to the invention provides a mechanism which can be activated easily even by non-expert users directly at the place of use of the sensor, avoiding the adoption of extreme conditions for preserving the sensor.

The described invention can be applied in the most different industrial and to nonindustrial fields, where morphology-changing and non-morphology-changing sensors are applied, such as for example the agroalimentary, medical and pharmaceutical, textile and electronic fields, in general for consumer goods or others.

The system thus conceived is susceptible of numerous modifications and variations, all of which are within the scope of the inventive concept as expressed in the accompanying claims.

The disclosures in Italian Patent Application no. BO2007A000159, from which this application claims priority, are incorporated herein by reference.

1-18. (canceled)

19. A device for protecting and activating sensitive elements of apparatuses having sensor capabilities, comprising a protective material with at least one spatially structured element which is adapted to be applied to the product to be protected, said material being selectable among materials which have properties of shape invariance when the material is placed in the conditions to which the sensitive elements are sensitive.

20. The device according to claim 19, wherein the protective structured element comprises a film made of a material which has at least one surface or interface for protecting the sensitive element which is spatially structured or pre-structured on a spatial scale ranging from 1 nanometer to 5 centimeters.

21. The device according to claim 19, adapted to constrain the surface of the sensitive element to maintain the shape and structure of the surface of said sensitive element even when said product is exposed to the conditions to which it is sensitive.

22. The device according to claim 19, adapted to avoid phase segregation processes when the sensitive element is exposed to the conditions to which said product or sensor is sensitive.

23. The device according to claim 19, adapted to avoid processes of any chemical alteration when the sensitive element is exposed to the conditions to which said sensitive element is sensitive.

24. The device according to claim 19, adapted to avoid any physical alteration when the sensitive element is exposed to the conditions to which said sensitive element is sensitive.

25. The device according to claim 19, adapted to avoid chemical reactions when the sensitive element is exposed to the conditions to which said sensitive element is sensitive.

26. The device according to claim 19, wherein said structured element comprises a label applied to the sensitive element to be protected.

27. The device according to claim 19, wherein said structured element is constituted by a label which comprises a base layer with a surface on which a structured configuration made of a different material is applied.

28. The device according to claim 19, wherein the sensitive element to be protected comprises a label.

29. The device according to claim 19, wherein the structured element is constituted by a multilayer film.

30. The device according to claim 19, wherein the material of which the device is made comprises one or more substances in the pure or mixed state, said substances being selectable among inorganic, organic, polymeric, biological or hybrid substances.

31. The device according to claim 19, wherein the structured element is a molded element.

32. The device according to claim 19, wherein the structured element itself is used as a mold for structuring the surface of the sensitive element.

33. The device according to claim 19, wherein the sensitive element is protected against exposure to the temperature ranging from the limits of −200° C. to 500° C.

34. The device according to claim 19, wherein the sensitive element is protected against exposure to any chemical agent.

35. The device according to claim 19, wherein the sensitive element is protected against exposure to any physical agent.

36. A method for protecting and activating the sensitive element of a sensor as set forth in claim 19, comprising the steps for:
a. selecting a protective material constituted by one or more substances capable of not changing state in the preservation conditions of the product;
b. forming at least one spatially structured element with a configuration whose morphology is mirror-symmetrical with respect to the surface of the product.
